(19) United States
(12) Patent Application Publication
(10) Pub. No.: US 2021/0117284 A1
(43) Pub. Date: Apr. 22, 2021

(54) SYSTEM AND METHOD FOR GENERATING APP-CONSISTENT BACKUPS UTILIZING CRASH-CONSISTENT METHODS AND NOT REQUIRING AN AGENT

(71) Applicant: EMC IP Holding Company LLC, Hopkinton, MA (US)

(72) Inventors: Nadav Azaria, Meitar (IL); Saar Cohen, Mishmeret (IL); Jehuda Shemer, Kfar Saba (IL)

(21) Appl. No.: 16/656,012

(22) Filed: Oct. 17, 2019

(51) Int. Cl. G06F 11/14; G06F 9/455

(52) U.S. Cl. CPC G06F 11/1464; G06F 11/1469; G06F 11/1461; G06F 2201/84; G06F 9/45533; G06F 2201/815; G06F 11/1448

(57) ABSTRACT

One example method includes receiving a notification that a backup has been created, performing an IO splitting process that includes duplicating one or more IOs issued by an application that is included in the backup so that there are two copies of each IO, storing one copy of each of the captured IOs in an IO journal, packaging the IO journal together with the backup to create a live image, and transmitting the live image to backup storage.

### FIELD OF THE INVENTION

Embodiments of the present invention generally relate to data backup and restore. More particularly, at least some embodiments of the invention relate to systems, hardware, software, computer-readable media, and methods for implementing application-consistent image level backups.

### BACKGROUND

Enterprises and other entities often use virtual machines (VM) for their operations. Because the VMs may have specific configurations and data that must be preserved, there is a need to back up the VMs so that in the event that a problem occurs that compromises a VM in some way, the backed up VM can be restored to a target system or device. Performing a backup process on a VM, particularly a running VM, presents some problems.

For example, backing up a VM when the VM is in a running state does not ensure that all in-flight activity is fully accounted for. Such in-flight activity may include input/output operations (IOs) involving the VM that take place after a snapshot of the VM has been taken, but before the next snapshot is taken. Thus, this type of backup approach does not ensure that the data and application are both consistent and, therefore, does not ensure that the restored VM contains enough accurate information to declare the restoration of the VM as fully successful.

One possible approach to obtaining a backup that is application-consistent might be to utilize an agent, deployed on the host being backed up, to interact with the application being backed up and to help ensure that the backup is taken at a suitable point-in-time. However, this method involves significant complexity inasmuch as it requires the deployment of agents, and verification that the agents are compatible with the application that is targeted for backup.

Also, this method has some implications with respect to the application itself, since these backups are usually performed only after pausing and quiescing the application to ensure that no new IOs are generated which would otherwise compromise the application-consistent nature of the backup. However, pausing the application each time a backup is needed degrades the performance and availability of the application that is being backed up. Such an approach to VM backup is particularly problematic where there is a need to take frequent backups of the VM that includes the application, since the application, and associated IOs, must be stopped each time before the backup can be performed.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example operating environment and components.

FIG. 2 discloses aspects of an example live-vm-image.

FIG. 3 discloses aspects of an example host device.

FIG. 4 discloses aspects of an example method for creating a live-vm-image.

FIG. 5 discloses aspects of an example method for restoring a VM using a live-vm-image.

### DETAILED DESCRIPTION OF SOME EXAMPLE EMBODIMENTS

Embodiments of the present invention generally relate to data backup and restore. More particularly, at least some embodiments of the invention relate to systems, hardware, software, computer-readable media, and methods for implementing image level backups.

In general, example embodiments of the invention may involve the creation and use of a ‘live-vm-image image-level backup. The live-vm-image backup contrasts with a VM backup taken at time ‘t’ that includes an image for each of the VM hard-disks. Particularly, the live-vm-image is augmented with an IO journal log that logs, in chronological order, any IOs performed from time ‘t’ up until time t+p, where ‘p’ is some parameter of the system. In this way, a snapshot or other backup taken prior to time t+p can be rolled forward, using the IO operations captured in the IO journal log, to the desired point in time (PIT), thereby providing a VM backup of applications and data that is fully consistent as of the desired PIT.

Thus, the creation and use of the IO journal log enables a user to spin off, or create, a VM having a configuration that corresponds to any desired point in time that falls in the time span defined by the boundaries [t, t+p]. In some cases, multiple different VMs may be spun off from a live-vm-image, where each spun off VM is consistent as of a particular PIT, and a user or other entity can then select the VM that best corresponds to the PIT that is of interest to the user. This approach may significantly reduce, or eliminate, the probability that the VM backup will be created in an inconsistent state, and in cases where the VM backup is application-inconsistent, and/or otherwise inconsistent, a user may browse to a close point-in-time and then roll the VM backup forward to that PIT using as many of the IO journal log entries as may be needed.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of some embodiments of the invention is that such embodiments may provide agent-less, image-level VM backups that are application-consistent, that is, such backups can be created without the use or requirement of an agent residing on the VM that is backed up. As another example, one or more embodiments of the invention may provide for the creation of image-level VM backups at multiple different points in time, without requiring the VM applications to be stopped or quiesced during creation of the backup and, as such, these embodiments may enable consistent and reliable application operation while still providing for image-level backups of the associated VM at one or more different PITs. As well, one or more embodiments may use crash-consistent methods to create application-consistent image-level backups. Further, some embodiments provide for creation of an image-level backup, at a particular point in time, of a VM while the VM and one or more of its applications are in a running state. Various other advantages of example embodiments of the invention will be apparent from this disclosure.

### A. Aspects of an Example Operating Environment

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, backup and restore operations involving, among other things, the creation and/or use of one or more live-vm-images. Such backup and restore operations may include, but are not limited to, data read/write/delete operations, snapshots, data deduplication operations, data backup operations including creation of an application-consistent image-level VM backup using crash-consistent methods, data restore operations including the use of one or more live-vm-images to restore a VM to a target system or device, data cloning operations, data archiving operations, and disaster recovery operations. Various other example operations are disclosed elsewhere herein. More generally, the scope of the invention embraces any operating environment in which one, some, or all, of the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment. As well, and discussed in more detail below, some embodiments can be employed in a cloud storage environment, a customer on-premises environment, and/or any other environment in which one or more VMs may be employed.

New and/or modified data collected and/or generated, such as VM backups and one or more live-vm-images, in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example public cloud storage environments in connection with which embodiments of the invention may be employed include, but are not limited to, Microsoft Azure, Amazon AWS, and Google Cloud. More generally however, the scope of the invention is not limited to employment of any particular type or implementation of cloud storage.

In addition to the storage environment, the operating environment may also include one or more clients that are capable of collecting, modifying, and creating, data. As such, a particular client may employ, or otherwise be associated with, one or more instances of each of one or more applications that perform such operations with respect to data.

Devices in the operating environment may take the form of software, physical machines, or virtual machines (VM), or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures and may provide the functionality of a physical computer. A VM implementation may comprise, or at least involve the use of, hardware and/or software. An image of a VM may take various forms, such as a .VMDK file for example.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, example backups in connection with which embodiments of the invention may be employed include, but are not limited to, full backups, partial backups, clones, snapshots, and incremental or differential backups.

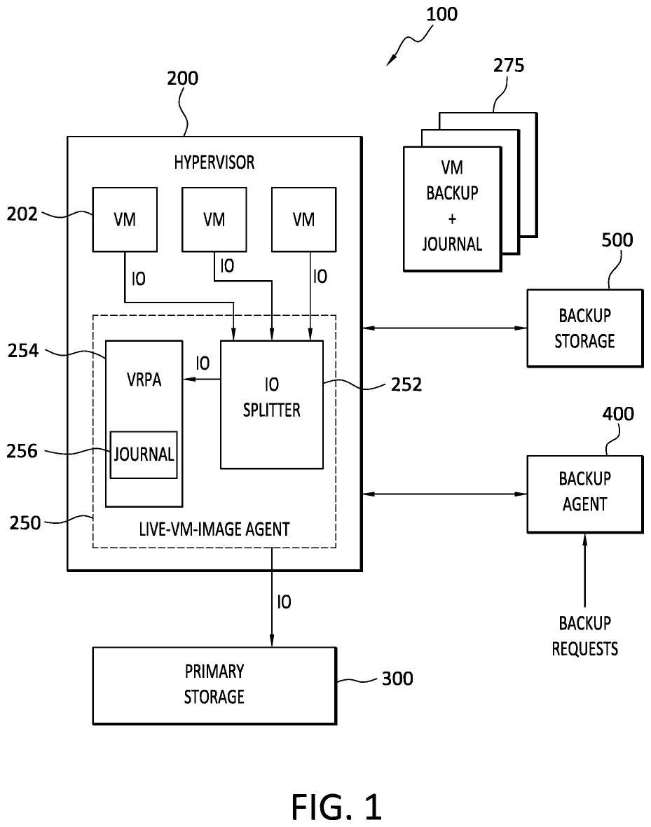

With particular attention now to FIG. 1, one example of an operating environment for embodiments of the invention is denoted generally at 100. In general, the operating environment 100 can take any form that will enable performance of the disclosed processes and operations. As such, the operating environment 100 is presented only by way of example, and is not intended to limit the scope of the invention. Moreover, the functional allocation disclosed in connection with the operating environment 100 is likewise presented only by way of example and, in other embodiments, the disclosed functions can be allocated amongst the disclosed entities in any other way that will still enable performance of those functions.

The example operating environment 100 may include, for example, a hypervisor 200 that communicates with primary storage 300, a backup agent 400 that may comprise software operable to create VM backups according to one or more predefined policies, and backup storage 500, which can be implemented in the form of a Dell-EMC DataDomain environment for example, which stores VM backups and their associated journals, as discussed below. While not specifically indicated in FIG. 1, the backup storage 500, backup agent 400, and primary storage 300, may all communicate with each other as well. In some embodiments, the backup agent 400 and associated backup system may be combined together with the hypervisor 200, but that is not required.

In general, the hypervisor 200 hosts, or otherwise includes, any number of VMs 202 that are desired to be protected, that is, backed up. The hypervisor 200 may be, for example, a VMWare ESXi hypervisor, but that is not required and other hypervisors may be used. One, some, or all, of the VMs 202 may host or otherwise include one or more applications that issue IOs, such as read, write, and delete, operations for example, directly and/or indirectly to the primary storage 300. The applications running on the VMs 202 can be any type of application that generates new and/or modified data, including, but not limited to, SQL, Oracle, Exchange, email applications, media applications, word processing applications, database applications, engineering applications, and financial applications, for example.

In addition to the VMs 202, the hypervisor 200 also includes a live-vm-image agent 250. In general, the live-vm-image agent 250 operates to augment each backup created by backup agent 400 by adding an I/O journal to the backup. One example embodiment of a live-vm-image agent 250 takes the form of a RecoverPoint (RP) system that may include an IO splitter 252 that runs on the hypervisor 200 and intercepts IOs issued by applications hosted by the VMs 202, as shown in FIG. 1. The live-vm-image agent 250 may also include a virtual RecoverPoint appliance (vRPA) 254 which is a virtual machine that handles the replication and data protection tasks, receives tracked IOs from the IO splitter 252, and records those IOs in a journal 256. The journal 256 may, or may not, be persistently stored in memory or storage. More generally, element 254 may comprise, or consist of, any Data Protection Appliance (DPA), and is not limited to implementation as a vRPA.

As further indicated in FIG. 1, one or more live-vm-images 275 may be created, by the live-vm-agent 250 in cooperation with the backup agent 400, that are then stored in the backup storage 500 for later retrieval and restoration to one or more targets which may, or may not, be one of the VMs 202. In general, each live-vm-image 275 includes a backup of a VM 202 as well as a journal of IOs relating to that VM. By using the backup and the journal, a VM corresponding to a particular point in time can be spun off from the corresponding live-vm-image 275 and then restored to one or more targets.

### C. Aspects of an Example Live-vm-Image

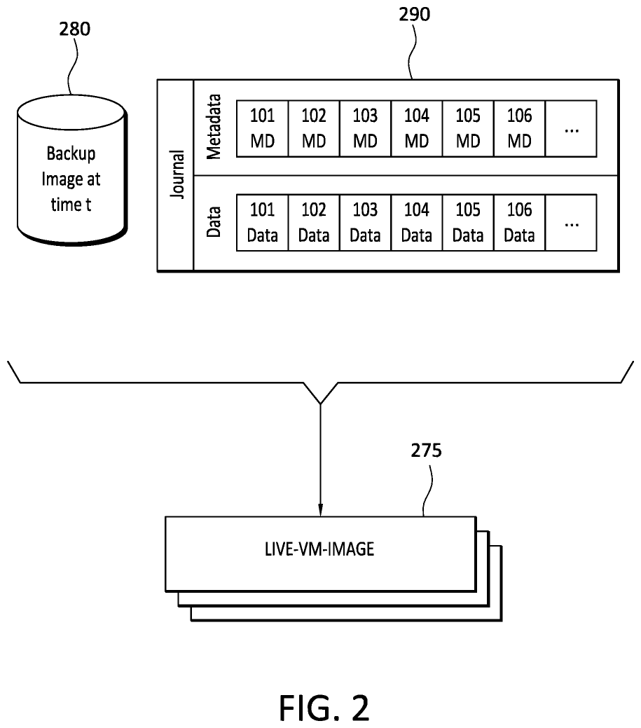

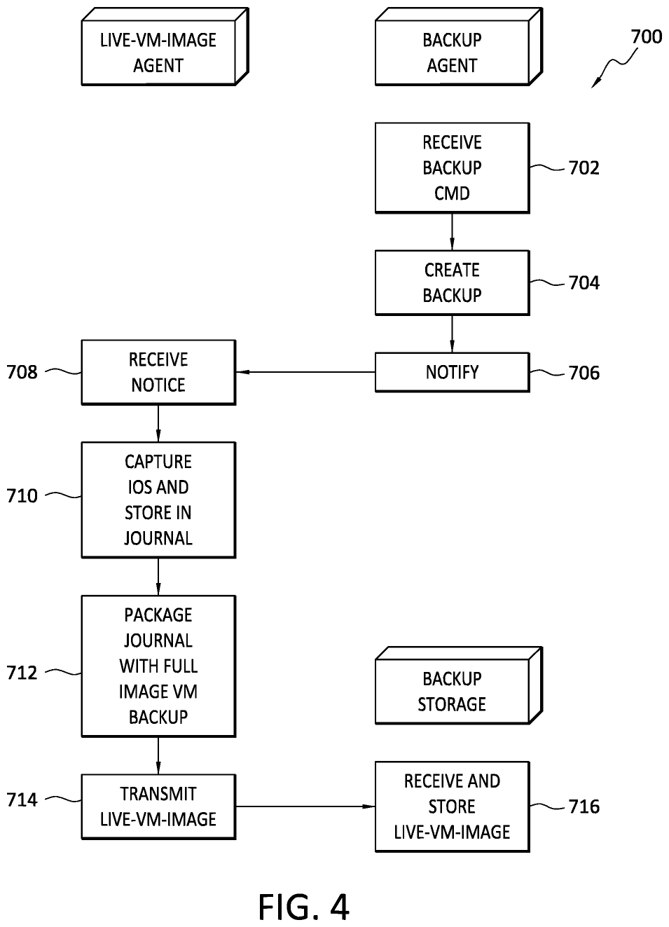

With continued reference to FIG. 1, and referring now to FIG. 2 as well, further details are provided concerning some example live-vm-images, such as the live-vm-images 275 referred to in FIG. 1. As indicated in FIG. 2, a live-vm-image 275 for example may comprise two components, namely, a VM image level backup 280 and an IO journal, or simply, a journal, 290. For reference purposes, the image level backup 280 is shown in FIG. 2 as having been created at time ‘t’ by, or at the direction of, an entity such as the backup agent 400 disclosed in FIG. 4. The image level backup 280 may be a crash-consistent backup.

As further shown in the illustrated example, the journal 290 may include both data and corresponding metadata for any number of IOs. In this particular example, six IOs are indicated, although any number of IOs can be captured in a journal 290. The particular number of IOs to be captured in the journal 290 may be specified, such as by providing “record the first six IOs after time t,” and/or the number of IOs to be captured in the journal 290 may be specified based the passage of a particular period of time, for example, that “record all IOs for the time period from t to t+5 seconds.” As disclosed elsewhere herein, the combination of the VM image level backup 280 and the journal 290 entries enables the spinoff of a VM that is application-consistent as of a particular point in time (PIT).

In view of the foregoing discussion, the journal 290 may be thought of as a stream, or streams, of data and metadata. For example, the journal 290 may comprise a stream of data, and a stream of corresponding metadata, and the two streams are kept in the journal 290 in association with each other and the corresponding IO. Thus, when the IOs in the journal 290 are applied to a full image VM backup, the metadata and data corresponding to each IO can be readily read out from the journal 290. In some embodiments, the journal 290 may comprise a single stream that includes both the data and associated metadata.

### D. Example Host and Server Configurations

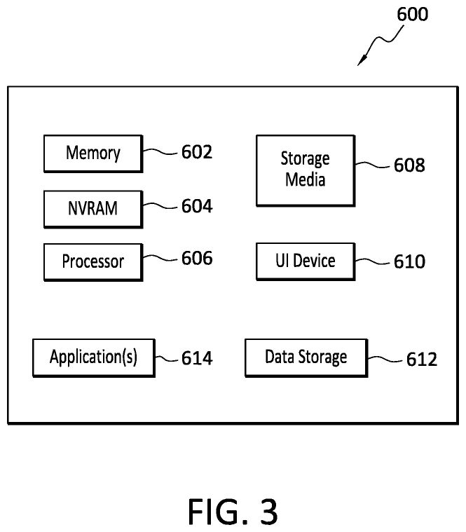

With reference briefly now to FIG. 3, any one or more of the entities and components disclosed, or implied by, FIG. 1, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 3.

In the example of FIG. 3, the physical computing device 600 includes a memory 602 which may include one, some, or all, of random access memory (RAM), non-volatile random access memory (NVRAM) 604, read-only memory (ROM), and persistent memory, one or more hardware processors 606, non-transitory storage media 608, IO device 610, and data storage 612. One or more of the memory components 602 and 604 of the physical computing device 600 may take the form of solid state device (SSD) storage. As well, one or more applications 614 are provided that comprise executable instructions.

Such executable instructions may take various forms including, for example, instructions executable to perform any method or portion thereof disclosed herein, and/or executable by/at any of a storage site, whether on-premises at an enterprise, or a cloud storage site, client, datacenter, or backup server, to perform any of the functions disclosed herein. As well, such instructions may be executable to perform any of the other operations, processes, and methods, and any portions thereof, disclosed herein including, but not limited to creation of a live-vm-image, and the spinoff of a VM from a live-vm-image.

### D. Example Methods

As noted herein, data backup is a crucial practice for any organization. Specifically, protecting VMs is particularly important for organizations that use virtualization in their data centers. Embodiments of the invention may employ what are sometimes referred to as crash-consistent, or point-in-time consistent, backups. A crash-consistent backup takes a snapshot of all the files of a VM at the exact same time. This means that any files that rely on each other are at the same point in time, and thus those files are consistent with each other. The term “crash-consistent” refers to the fact that capturing the backup is like capturing a restore point at the instant just prior to a server crash, server power off, or server reset, for example. As well, a backup such as a VM backup is application-consistent if the running applications on that VM are quiesced, that is, those applications have completed all their operations and flushed their respective buffers to disk. Application-consistent backups are useful, for example, in connection with database operating systems and applications such as SQL, Oracle, and Exchange.

With continued reference to the Figures, details are provided now concerning various example embodiments of methods for creating and using live-vm-images. In general, and as used herein, a live-vm-image refers to an image-level VM backup. More particularly, an image-level VM backup taken at time ‘t’ contains an image of each of the vm hard-disks. That image-level VM backup may also contain a description of the underlying VM hardware configuration. This image-level VM backup may be a crash-consistent backup.

As well, and discussed above in connection with FIG. 2, the live-vm-image may also contain an IO journal starting from time ‘t,’ that is, the time when a full image backup of the VM was created. Thus, collection of IO journal information may be synchronized with the completion of the full image backup, so that IO collection begins immediately following snapshot initiation, or completion. In some embodiments at least, the journal length may be determined by a predefined parameter. For example, the journal length may be defined using an amount of data generated by the application, by an amount of time to wait after the backup was taken, and/or by any other parameter that fulfills a customer consistency requirement. The journal may take the form of an ordered list data structure. Each element in the ordered list comprises a pair of (i) a hard-disk IO write operation and (ii) metadata indicating to which hard disk the IO operation was written, the offset inside the disk, usually referred to as local block addressing (LBA), and the length of the IO.

Note that references herein to IO write operations embrace any operation, or operations, that modifies/modify the data on the disk and may include different write commands (write10/16), writesame, punch (which can be thought of as a write of zeros), CAS (as a command or just the result), XCopy (the command if possible, or the copied result) or simple conversions of those (split or coalesced IOs, for example). The foregoing are presented only by way of example and are not intended to limit the scope of the invention.

With continued reference to FIGS. 1-3, and directing attention now to FIG. 4, details are provided concerning methods for creation of a live-vm-image, where one example method is denoted generally at 700. The method 700 may begin when an entity such as the backup agent receives a command 702 from a client or other entity to create, or cause the creation of, a backup. The backup may be a full-image backup of a VM for example. The backup agent then creates 704 the requested backup.

Before, during, or after, creation 704 of the backup, the backup agent may also send a notification 706 to an agent such as a live-vm-agent. The notification 706 may indicate to the live-vm-agent that the backup agent is creating, or has created, or will create, a full-image VM backup. Among other things, the notification 706 may identify the particular VM whose full image is created by the backup agent. The notification 706 may also indicate the time when the full-image VM backup has been created, or the time when creation of the full image is expected to be started and/or completed by the backup agent. The backup process performed by the backup agent may result in the creation of a crash-consistent full-image VM backup.

In some embodiments, the notification 706 may precede creation 704 of the full-image VM backup. In particular, the backup agent may notify any third-party regarding the creation and location of a new full-image image VM backup. Only after the notification is received 708 by the third party, will the backup agent create 704 the snapshot. Thus, in one particular embodiment, the backup agent may notify a third party, such as the live-vm-agent, that a backup is taken. In some embodiments, when the backup agent wishes to create a VM backup, the backup agent may perform a stun operation on the VM, such that the VM will stop any IO activity, and the backup agent then creates the backup. However, the stun operation is not required.

In any case, at some point after the live-vm-image agent has been notified 708 concerning a backup that will be, or has been, created by the backup agent, the live-vm-image agent identifies the particular VM of interest and, beginning at a time ‘t,’ intercepts 710 any IOs issued by one or more of the applications running on that VM. The time ‘t’ may be the time when the full-image VM backup begins, or the time when that backup is completed. In more detail, an IO splitter of the live-vm-agent may, as part of the operation 710 for example, intercept and duplicate each IO write, and/or other, operations performed by an application of a VM running on the same hypervisor as the IO splitter. One copy of the intercepted IO may be sent as usual to the primary storage, such as through an ESXi I/O stack for example. Another copy of the intercepted IO may be sent to an entity such as a virtual RecoverPoint appliance (vRPA) of the live-vm-image agent. The vRPA may then capture the intercepted IO in an IO journal corresponding to the VM that was identified in the notification. This capturing may also be performed as part of the operation 710.

After the IO journal has been populated, the live-vm-image agent may then create a live-vm-image 712 by packaging the IO journal together with the associated full-image VM backup. The live-vm-agent may then transmit 714 the live-vm-image to backup storage which may receive and store 716 the live-vm-image. As disclosed elsewhere herein, the live-vm-image may later be retrieved and used to restore a VM to one or more targets.

In connection with the example operations disclosed in FIG. 4, there are a variety of possible algorithms that may be implemented. One example of such an algorithm is as follows:

On New Backup at time t(B):
start collecting I/O journal for p seconds—splitter will send every incoming I/O to the vRPA during this time //p is the range parameter set by the user.
vRPA will create the live-vm-image by adding the accumulated I/O journal to the backup.
   With respect to capturing of the IOs, it is noted that in some cases, the vRPA may not be able to receive IOs arriving from the IO splitter, whether due to a failure or some other reason. In this circumstance, the IO splitter may store parts of the journal in memory, up to an amount of available or specified memory, and/or track the relevant IOs for later synchronization.

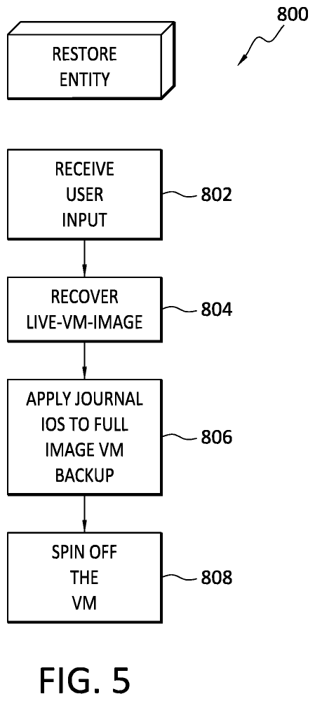

With reference now to FIG. 5, details are provided concerning methods for using a live-vm-image to restore a VM to a target, where one example of such a method is denoted generally at 800. This restoration process may also be referred to herein as the ‘spinning off’ of a VM from a live-vm-image. In general, the example method 800 may be performed by any single entity, or cooperatively by a combination of entities, capable of performing a restore process. Such entities may include, for example, a backup and restore server, a backup agent, or a backup/restore agent.

The method 800 may begin 802 when the restore entity prompts a user for, and/or receives input from a user comprising, a point in the range [t, t+p] where ‘t’ is the time the backup was taken, and ‘p’ is the range length which may have been specified by the user or another entity. After receiving 802 the user input concerning the range point, and user input concerning the VM of interest, the restore entity may then recover 804 the live-vm-image corresponding to that VM.

As noted elsewhere herein, the recovered live-vm-image includes a journal of IOs that were captured after the full-image VM backup was taken, and each of the IOs corresponds to a respective point in time within the range [t, t+p]. Thus, the restore entity may read out the IOs from the beginning of the IO journal up to the time point specified by the user and then apply 806 those IOs to the full-image VM backup to create a restored VM that may be application-consistent.

The restored VM may then be spun off 808 and restored to one or more target devices and/or entities. It is noted that the method 800 may be performed repeatedly. Thus, in the event that a specific point-in-time identified by the user does not allow for a successful application recovery, the user can choose to repeat this process and select a different PiT, until arriving at a specific point in time in the specified range from which the VM application(s) is/are able to recover. In some embodiments, the user may begin with attempting recovery from the backup itself, that is, time ‘t’, and then attempt to move forward in the range if needed. Since the IO journal may be maintained in a single-I/O granularity, the user may, given a reasonably long time-range p, be likely to reach a point where the VM is recoverable in an application-consistent state.

### E. Further Example Embodiments

Following are some further example embodiments of the invention. These are presented only by way of example and are not intended to limit the scope of the invention in any way.

Embodiment 1. A method comprising: receiving a notification that a backup has been created; performing an IO splitting process that comprises duplicating one or more IOs issued by an application that is included in the backup so that there are two copies of each IO; storing one copy of each of the captured IOs in an IO journal; packaging the IO journal together with the backup to create a live image; and transmitting the live image to backup storage.

Embodiment 2. The method as recited in embodiment 1, wherein the backup is a full-image VM backup.

Embodiment 3. The method as recited in embodiment 2, wherein the operations are performed by an agent running on the same hypervisor as the VM upon which the full-image VM backup is based.

Embodiment 4. The method as recited in any of embodiments 1-3, wherein the live image is a live-vm-image, and the backup is a snapshot of a VM.

Embodiment 5. The method as recited in any of embodiments 1-4, wherein the captured IOs fall within a user-specified time range.

Embodiment 6. The method as recited in any of embodiments 1-5, wherein the notification is received from a backup agent.

Embodiment 7. The method as recited in any of embodiments 1-6, wherein the IO splitting process further comprises the operation of forwarding another copy of each of the IOs to primary storage.

Embodiment 8. The method as recited in any of embodiments 1-7, wherein the IO splitting process comprises intercepting the IOs issued by the application.

Embodiment 9. The method as recited in any of embodiments 1-8, wherein each of the IOs corresponds to a respective point in time within a specified time range.

Embodiment 10. The method as recited in any of embodiments, wherein the IO journal includes, for each IO, a corresponding ordered pair that comprises data and metadata.

Embodiment 11. A method comprising: receiving input that identifies a particular point in time, and the particular point in time falls within a time range specified for a particular backup; recovering a live image that includes the backup and an IO journal that includes one or more IOs; applying, to the backup, any IO whose corresponding time falls between a beginning of the IO journal and the particular point in time; and spinning off a VM that comprises the backup and all applied IOs.

Embodiment 12. The method as recited in embodiment 11, wherein the IO journal includes, for each IO, a corresponding ordered pair that comprises data and metadata.

Embodiment 13. The method as recited in any of embodiments 11-12, wherein each of the IOs corresponds to a respective point in time within the specified time range.

Embodiment 14. The method as recited in any of embodiments 11-13, wherein the spun off VM is application-consistent.

Embodiment 15. The method as recited in any of embodiments 11-14, wherein the backup is crash-consistent.

Embodiment 16. The method as recited in any of embodiments 11-15, wherein the live image is a live-vm-image.

Embodiment 17. The method as recited in any of embodiments 11-16, wherein a beginning of the time range is a time ‘t’ when the backup was created.

Embodiment 18. The method as recited in any of embodiments 11-17, wherein the IO journal includes all IOs that took place within the specified time range.

Embodiment 19. The method as recited in any of embodiments 11-18, wherein one or more of the IOs is a hard disk IO write operation.

Embodiment 20. The method as recited in any of embodiments 11-19, wherein the operations further comprise restoring the spun off VM to a target entity.

Embodiment 21. A method for performing any of the operations, methods, or processes, or any portion of any of these, disclosed herein.

Embodiment 22. A non-transitory storage medium having stored therein instructions that are executable by one or more hardware processors to perform the operations of any one or more of embodiments 1 through 21.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A non-transitory storage medium having stored therein instructions that are executable by one or more hardware processors to perform operations comprising:
receiving a notification that a backup has been created;
performing an IO (Input/Output operation) splitting process that comprises duplicating one or more IOs issued by an application that is included in the backup so that there are two copies of each IO;
storing one copy of each of the captured IOs in an IO journal;
packaging the IO journal together with the backup to create a live image of a Virtual Machine (VM); and
transmitting the live image to backup storage.

2. The non-transitory storage medium as recited in claim 1, wherein the live image is an image-level backup of the VM.

3. The non-transitory storage medium as recited in claim 2, wherein the operations are performed by an agent running on the same hypervisor as the VM upon which the image-level backup of the VM is based.

4. The non-transitory storage medium as recited in claim 1, wherein the backup is a snapshot of the VM.

5. The non-transitory storage medium as recited in claim 1, wherein the captured IOs fall within a user-specified time range.

6. The non-transitory storage medium as recited in claim 1, wherein the notification is received from a backup agent.

7. The non-transitory storage medium as recited in claim 1, wherein the IO splitting process further comprises the operation of forwarding a third copy of each of the IOs to primary storage.

8. The non-transitory storage medium as recited in claim 1, wherein the IO splitting process comprises intercepting the IOs issued by the application.

9. The non-transitory storage medium as recited in claim 1, wherein each of the IOs corresponds to a respective point in time within a specified time range.

10. The non-transitory storage medium as recited in claim 1, wherein the IO journal includes, for each IO, a corresponding ordered pair that comprises data and metadata.

11. A non-transitory storage medium having stored therein instructions that are executable by one or more hardware processors to perform operations comprising:
receiving input that identifies a particular point in time, and the particular point in time falls within a time range specified for a particular backup;
recovering a live image that is a packaging together of the backup and an IO (Input/Output operation) journal that includes one or more IOs associated with the backup, and the live image is recovered from backup storage;
applying, to the backup, any IO whose corresponding time falls between a beginning of the IO journal and the particular point in time; and
spinning off a VM (Virtual Machine) that comprises the backup and all applied IOs.

12. The non-transitory storage medium as recited in claim 11, wherein the IO journal includes, for each IO, a corresponding ordered pair that comprises data and metadata.

13. The non-transitory storage medium as recited in claim 11, wherein each of the IOs corresponds to a respective point in time within the specified time range.

14. The non-transitory storage medium as recited in claim 11, wherein the spun off VM is application-consistent.

15. The non-transitory storage medium as recited in claim 11, wherein the backup is crash-consistent.

16. The non-transitory storage medium as recited in claim 11, wherein the live image is a live-vm-image.

17. The non-transitory storage medium as recited in claim 11, wherein a beginning of the time range is a time ‘t’ when the backup was created.

18. The non-transitory storage medium as recited in claim 11, wherein the IO journal includes all IOs that took place within the specified time range.

19. The non-transitory storage medium as recited in claim 11, wherein one or more of the IOs is a hard disk IO write operation.

20. The non-transitory storage medium as recited in claim 11, wherein the operations further comprise restoring the spun off VM to a target entity.
